(19) United States
(12) Patent Application Publication
(10) Pub. No.: US 2026/0105691 A1
(43) Pub. Date: Apr. 16, 2026

(54) FACIAL BLENDSHAPES FOR AVATARS

(71) Applicant: QUALCOMM Incorporated, San Diego, CA (US)

(72) Inventors: Ke-Li CHENG, San Diego, CA (US); Wei-Lun CHANG, Taipei City (TW); Pin-Yen HUANG, Zhubei City (TW); Tejas Govind INDANI, Latur (IN); Nicholas CROPPER, San Diego, CA (US); Sean SHEN, Taipei City (TW); Matthew FISCHLER, San Diego, CA (US); Michel Adib SARKIS, San Diego, CA (US)

(21) Appl. No.: 19/221,259

(22) Filed: May 28, 2025

Related U.S. Application Data
(60) Provisional application No. 63/707,689, filed on Oct. 15, 2024.

(51) Int. Cl. G06T 17/20; G06T 13/40

(52) U.S. Cl. CPC G06T 17/20; G06T 13/40

(57) ABSTRACT

Systems and techniques are provided for generating a mesh model. For instance, a process can include generating, based on an obtained frame, a first set of blendshape coefficients using an encoder, wherein the encoder is trained using a first dataset and a second dataset, the first dataset including labelled training data and the second dataset including unlabeled training data; inputting the first set of blendshape coefficients to a decoder, and generating, based on the first set of blendshape coefficients, a set of features for generating a mesh model.

### CROSS-REFERENCE TO RELATED APPLICATIONS

This application claims the benefit of U.S. Provisional Patent Application No. 63/707,689, filed Oct. 15, 2024, which is hereby incorporated by reference in its entirety and for all purposes.

### FIELD

The present disclosure generally relates to systems and techniques for generating three-dimensional (3D) models. For example, aspects of the present disclosure relate to a technique for generating facial avatars using blendshapes.

### BACKGROUND

Many devices and systems allow a scene to be captured by generating frames (also referred to as images) and/or video data (including multiple images or frames) of the scene. For example, a camera or a computing device including a camera (e.g., a mobile device such as a mobile telephone or smartphone including one or more cameras) can capture a sequence of frames of a scene. The frames and/or video data can be captured and processed by such devices and systems (e.g., mobile devices, IP cameras, etc.) and can be output for consumption (e.g., displayed on the device and/or other device). In some cases, the frame and/or video data can be captured by such devices and systems and output for processing and/or consumption by other devices.

A frame can be processed (e.g., using object detection, recognition, segmentation, etc.) to determine objects that are present in the frame, which can be useful for many applications. For instance, a model can be determined for representing an object in a frame and the model can be used to facilitate effective operation of various systems. Examples of such applications and systems include augmented reality (AR), robotics, automotive and aviation, three-dimensional scene understanding, object grasping, object tracking, in addition to many other applications and systems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for generating a mesh model is provided. The apparatus includes at least one memory and at least one processor coupled to the at least one memory configured to: generate, based on an obtained frame, a first set of blendshape coefficients using an encoder, wherein the encoder is trained using a first dataset and a second dataset, the first dataset including labelled training data and the second dataset including unlabeled training data; input the first set of blendshape coefficients to a decoder; and generate, based on the first set of blendshape coefficients, a set of features for generating a mesh model.

As another example, a method for generating a mesh model is provided. The method includes: generating, based on an obtained frame, a first set of blendshape coefficients using an encoder, wherein the encoder is trained using a first dataset and a second dataset, the first dataset including labelled training data and the second dataset including unlabeled training data; inputting the first set of blendshape coefficients to a decoder; and generating, based on the first set of blendshape coefficients, a set of features for generating a mesh model.

In another example, a non-transitory computer-readable medium having stored thereon instructions is provided. The instructions, when executed by at least one processor, cause the at least one processor to: generate, based on an obtained frame, a first set of blendshape coefficients using an encoder, wherein the encoder is trained using a first dataset and a second dataset, the first dataset including labelled training data and the second dataset including unlabeled training data; input the first set of blendshape coefficients to a decoder; and generate, based on the first set of blendshape coefficients, a set of features for generating a mesh model.

As another example, an apparatus for generating a mesh model is provided. The apparatus includes: means for generating, based on an obtained frame, a first set of blendshape coefficients using an encoder, wherein the encoder is trained using a first dataset and a second dataset, the first dataset including labelled training data and the second dataset including unlabeled training data; means for inputting the first set of blendshape coefficients to a decoder; and means for generating, based on the first set of blendshape coefficients, a set of features for generating a mesh model.

In some aspects, one or more of the apparatuses described above is or is part of a vehicle (e.g., a computing device of a vehicle), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, an apparatus includes a camera or multiple cameras for capturing one or more images. In some aspects, the apparatus further includes a display for displaying one or more images, notifications, and/or other displayable data. In some aspects, the apparatus can include one or more sensors, which can be used for determining the location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example of three-dimensional (3D) facial model and corresponding two-dimensional (2D) facial images overlaid with landmarks projected from the 3D facial model, in accordance with some examples;

FIG. 2 illustrates an example head mounted XR system with user facing cameras for generating a 3D facial model, in accordance with some examples;

FIG. 3 is a diagram illustrating an example of a 3D modeling system, in accordance with some examples;

FIG. 4 is a block diagram illustrating a technique for facial blendshape avatars, in accordance with aspects of the present disclosure;

FIG. 5 illustrates an encoder for generating facial blendshape avatars, in accordance with aspects of the present disclosure;

FIG. 6 is a block diagram illustrating a training structure for disentangling identifier information from blendshape coefficients, in accordance with aspects of the present disclosure;

FIG. 7 is a block diagram illustrating a decoder capable of supporting multiple source avatars, in accordance with aspects of the present disclosure;

FIG. 8 is a block diagram illustrating techniques for generalizing facial blendshape generation, in accordance with aspects of the present disclosure;

FIG. 9 illustrates a flowchart of a process for generating a mesh model, in accordance with aspects of the present disclosure;

FIG. 10 is a block diagram illustrating an example of a deep learning network, in accordance with some examples;

FIG. 11 is a block diagram illustrating an example of a convolutional neural network, in accordance with some examples; and

FIG. 12 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The generation of three-dimensional (3D) models for physical objects can be useful for many systems and applications, such as for extended reality (XR) (e.g., including augmented reality (AR), virtual reality (VR), mixed reality (MR), etc.), robotics, automotive, aviation, 3D scene understanding, object grasping, object tracking, in addition to many other systems and applications. In AR environments, for example, a user may view images (also referred to as frames) that include an integration of artificial or virtual graphics with the user's natural surroundings. AR applications allow real images to be processed to add virtual objects to the images or to display virtual objects on a see-through display (so that the virtual objects appear to be overlaid over the real-world environment). AR applications can align or register the virtual objects to real-world objects (e.g., as observed in the images) in multiple dimensions. For instance, a real-world object that exists in reality can be represented using a model that resembles or is an exact match of the real-world object. In one example, a model of a virtual airplane representing a real airplane sitting on a runway may be presented by the display of an AR device (e.g., AR glasses, AR head-mounted display (HMD), or other device) while the user continues to view his or her natural surroundings through the display. The viewer may be able to manipulate the model while viewing the real-world scene. In another example, an actual object sitting on a table may be identified and rendered with a model that has a different color or different physical attributes in the AR environment. In some cases, artificial virtual objects that do not exist in reality or computer-generated copies of actual objects or structures of the user's natural surroundings can also be added to the AR environment.

There is an increasing number of applications that use face data (e.g., for XR systems, for 3D graphics, for security, among others), leading to a large demand for systems with the ability to generate detailed 3D face models (as well as 3D models of other objects) in an efficient and high-quality manner. There also exists a large demand for generating 3D models of other types of objects, such as 3D models of vehicles (e.g., for autonomous driving systems), 3D models of room layouts (e.g., for XR applications, for navigation by devices, robots, etc.), among others. Generating a detailed 3D model of an object (e.g., a 3D face model) typically requires expensive equipment and multiple cameras in an environment with controlled lighting, which hinders large-scale data collection.

Performing 3D object reconstruction (e.g., to generate a 3D model of an object, such as a face model) from one or more images can be challenging. Using a face as an illustrative example of a 3D object, 3D face reconstruction can be difficult based on the need to reconstruct the face geometry (e.g., shape) and the facial expression. In addition, it can be difficult to accurately reconstruct facial expressions for portions of the face that can experience high variations in appearance. In one illustrative example, the eyes of a face can be moved to extreme gaze directions (e.g., looking for to one side, crossing eyes, or the like). In another illustrative example, the upper and lower lips of the mouth of a face are controlled by muscles that allow a large variety of difficult to reconstruct mouth shapes (e.g., smiling, frowning, baring teeth, twisting lips, etc.).

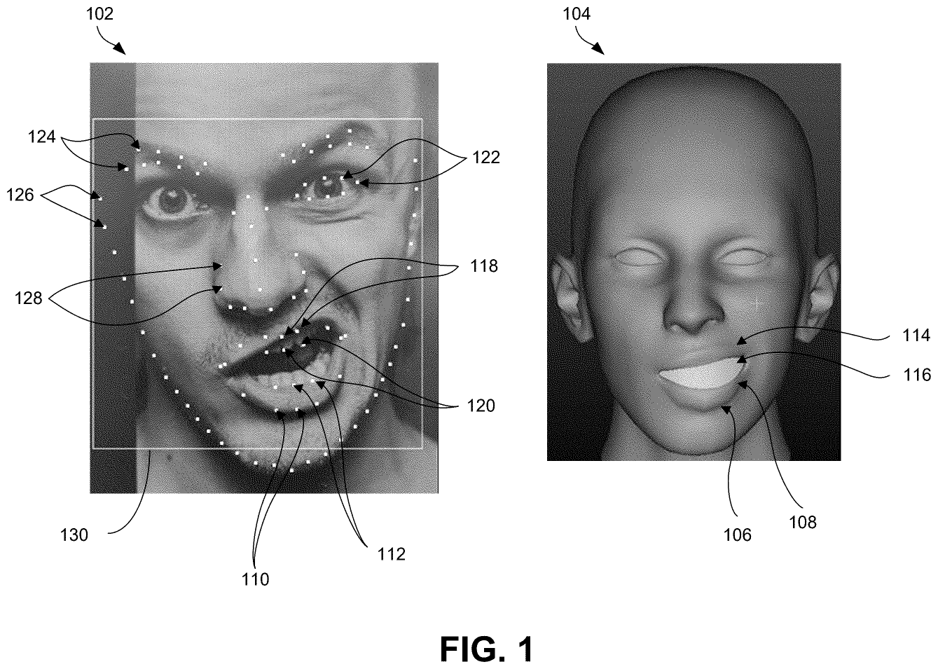

FIG. 1 illustrates a two-dimensional (2D) facial image 102 and a corresponding 3D facial model 104 generated from the 2D facial image 102 using a 3D morphable model (3DMM). As illustrated in FIG. 1, white dots overlaid on a 2D facial image 102 can represent a projection of 3D vertices of a 3D facial model 104 back onto the original 2D facial image 102 used to generate the 3D facial model 104. For instance, in the illustration of FIG. 1, points corresponding to 3D vertices of major features of the 3D facial model (which can be referred to as landmarks or 2D landmarks) are depicted as white dots. As shown, landmarks 110, 112, 118, 120, 122, 124, 126, 128 are included for the outlines of lips, nose, mouth, eyes, eyebrows, nose, among others. Although the 3D facial model 104 may contain a much larger number of vertices, for purposes of illustration, only a small number of projected 3D vertices corresponding to the above listed facial features are shown. In the illustrated example of FIG. 1, landmarks corresponding to the inner contour 108 of the lower lip of the 3D facial model 104 projected onto a 2D image can include landmarks 112. Similarly, the landmarks corresponding to the outer contour 106 of the lower lip of the 3D facial model 104 can include landmarks 110.

FIG. 1 also illustrates the outer contour 114 and inner contour 116 of the upper lip of the 3D facial model 104. In some examples, landmarks corresponding to the outer contour 114 of the upper lip can include landmarks 118 and 124 and landmarks corresponding to the inner contour 116 of the upper lip can include landmarks 120. Additional landmarks projected from the 3D facial model 104 can include landmarks 122 corresponding to the left eye, landmarks 124 corresponding to the right eyebrow, landmarks 126 corresponding to the overall face outline, and landmarks 128 corresponding to the nose. As noted above, each of the landmarks (e.g., of the outer contour 114, the inner contour 116, landmarks 120, landmarks 122, landmarks 124, landmarks 126, and landmarks 128) can result from a projection of the 3D facial model 104 onto the 2D facial image 102.

In some aspects, the 3D facial model 104 can include a representation of a facial expression in the 2D facial image 102. In one illustrative example, the facial expression representation can be formed from blendshapes. A blendshape can correspond to an approximate semantic parametrization of all or a portion of a facial expression, and a blendshape can semantically represent movement of muscles or portions of facial features (e.g., opening/closing of the jaw, raising/lowering of an eyebrow, opening/closing eyes, etc.). For example, a blendshape can correspond to a complete facial expression, or correspond to a “partial” (e.g., “delta”) facial expression. Examples of partial expressions include raising one eyebrow, closing one eye, moving one side of the face, etc. In one example, an individual blendshape can approximate a linearized effect of the movement of an individual facial muscle. In some cases, the semantic representation can be modeled to correspond with movements of one or more facial muscles. In some cases, each blendshape can be represented by a blendshape coefficient paired with a corresponding blendshape vector.

In some examples, the 3D facial model 104 can include a representation of the facial shape in the 2D facial image 102. In some cases, the facial shape can be represented by a facial shape coefficient paired with a corresponding facial shape vector. In some implementations a 3D model engine (e.g., a machine learning model) can be trained (e.g., during a training process) to enforce a consistent facial shape (e.g., consistent facial shape coefficients) for a 3D facial model regardless of a pose (e.g., pitch, yaw, and roll) associated with the 3D facial model. For example, when the 3D facial model is rendered into a 2D image for display, the 3D facial model can be projected onto a 2D image using a projection technique. While a 3D model engine that enforces a consistent facial shape independent of pose, the projected 2D image may have varying degrees of accuracy based on the pose of the 3D facial model captured in the projected 2D image.

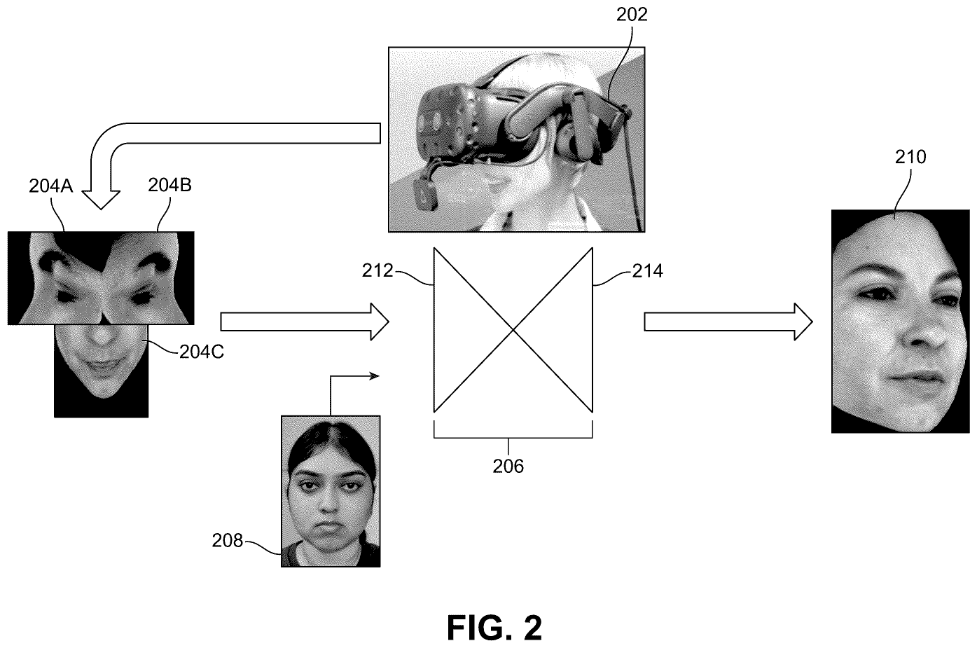

As shown in FIG. 2, a 3D modeling system 206 can utilize input frames such as oblique frames 204A, 204B, 204C, and/or 208 to generate the 3D facial model 210. As shown in FIG. 2, the 3D modeling system 206 can also generate and/or apply a texture to the underlying 3D model (e.g., the 3D facial model 104 of FIG. 1) to provide a digital representation of the user wearing the head mounted XR system 202. In one illustrative example, a 3D morphable model (3DMM) can be used to represent the geometry of the user's head. In some cases, a 3DMM may lack capability to accurately reproduce the inner mouth and eyeballs of the user. In some cases, the resulting 3D facial model 210 can produce unrealistic results in the eye and mouth regions.

In some cases, the 3D modeling system 206 may include an encoder 212 and a decoder 214. The encoder 212 may accept input, such as oblique frames 204A, 204B, 204C, and/or 208, and generate a latent vector (also referred to herein as latent code) that represents the input frames. In some cases, this latent vector may be a blendshape vector including blendshape coefficients. The decoder 214 may use (e.g., decode) the latent vector to generate the 3D facial model 210.

In some cases, blendshapes may be good for representing cartoonish avatars which do not attempt to photo realistically represent a person. However, blendshapes may not be suited for use with photo-realistic avatars as blendshapes typically are not capable of representing a sufficiently large and non-linear latent space for the breath of facial representations plausible for use with a photo-realistic avatar.

Systems, apparatuses, processes (or methods), and computer-readable media (collectively referred to as “systems and techniques”) are described herein for generating a facial blendshape 3D mesh models for avatars based on one or more images of a person (e.g., driver). In some examples, as described in more detail below, the systems and techniques can generate a detailed 3D mesh model for an avatar (e.g., a source avatar) based on expressions of the person using blendshapes. The systems and techniques can include generating a first set of blendshape coefficients using an encoder based on an obtained frame. The obtained frame includes an image of a person. The encoder is trained using a first dataset, such as a training dataset, and a second dataset, such as in the wild data (e.g., unlabeled data). The first dataset (e.g., training dataset) includes labelled ground truths and images of the first dataset may be captured in a more controlled environment as compared to images of the second dataset. For example, images of the first dataset may be captured using a multi-view scanner system. Images of the second dataset (e.g., in the wild data) may be unlabeled with ground truth labels and the images may be captured in a less controlled environment. For example, images of the second dataset may be captured using cameras of an XR system and may include, for example, backgrounds, different lighting conditions, distortion, etc. In some cases, multiple loss values may be determined when training on the first dataset, such as a blendshape loss, a latent code loss, and/or a pixel loss. In some cases, fewer loss values, or one loss value, may be determined based on the second dataset. The determined loss values may be used to train the encoder.

In some cases, a mesh model of a neutral face for the person may be received. The mesh model of the neutral face may be used to generate the set of features for generating a mesh model of the avatar along with the blendshape coefficients. In some cases, the mesh model of the neutral face may be generated based on a set of shape coefficients and blendshape coefficients determined during an enrollment procedure. The mesh model of the neutral face may help the encoder disentangle shape coefficients from blendshape coefficients.

In some cases, a source face identifier associated with a source avatar may be received, for example, by a mapper of the decoder. The source face identifier may be used to generate the mesh model along with the blendshape coefficients. In some cases, the source face identifier may be a vector generated based on an image of a neutral face. Additionally, one or more adaptive instance normalization (ADAIN) blocks may be used to generate the mesh model using the source face identifier. By using the source face identifier and ADAIN blocks, multiple source identifiers may be supported without using per source identifier ML models.

In some examples, dynamic noise may be added during training. This dynamic noise may be added to blendshape coefficients output by the encoder and the blendshape coefficients with noise may be used to train the mapper of the decoder (e.g., other portions of the decoder, such as for mesh and texture synthesis, may be fixed). In some cases, the dynamic noise may be added based on a standard deviation for the dynamic noise.

In some cases, the decoder may be trained using blendshape coefficients where one or more mutually exclusive blendshape coefficients have been removed. For example, blendshape coefficients may sometimes include mutually exclusive blendshape coefficients, such as a coefficient indicating that an eye is facing left and another coefficient indicating that the same eye is facing right. In some cases, a set of mutually exclusive blendshape coefficients may be defined (e.g., manually defined by one or more persons) and where mutually exclusive coefficients appear in predicated blendshape coefficients from the encoder, some of the mutually exclusive blendshape coefficients may be removed. For example, for two mutually exclusive blendshape coefficients, the smaller coefficient value may be removed. Removing some of the mutually exclusive blendshapes helps make the blendshape coefficients sparse and can reduce the chances that multiple sets of blendshape coefficients can be used to represent an expression.

Various aspects of the techniques described herein will be discussed below with respect to the figures.

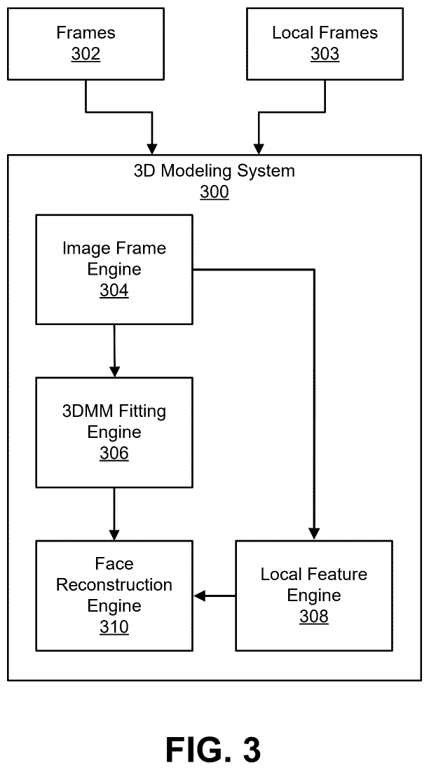

FIG. 3 is a diagram illustrating an example of a 3D modeling system 300 that can generate a 3D model (e.g., a 3D morphable model (3DMM)) using at least one image frame 302. The 3D modeling system 300 also obtains local frames (e.g., frames from a user facing camera of the head mounted XR system 202 of FIG. 2). As shown in FIG. 3, the 3D modeling system 300 includes an image frame engine 304, a 3D model fitting engine 306, and a face reconstruction engine 310. While the 3D modeling system 300 is shown to include certain components, one of the ordinary skill will appreciate that the 3D modeling system 300 can include more components than those shown in FIG. 3. The components of the 3D modeling system 300 can include software, hardware, or one or more combinations of software and hardware. For example, in some implementations, the components of the 3D modeling system 300 can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the 3D modeling system 300.

The image frame engine 304 can obtain or receive an image frame 302 and/or local frames 303 captured by an image sensor, from storage, from memory, from an external source (e.g., a server, an external memory accessed via a network, or other external source), or the like. In some cases, the image frame can be included in a sequence of frames (e.g., a video, a sequence of standalone or still images, etc.). In one illustrative example, each frame of the sequence of frames can include a grayscale component per pixel. Other examples of frames include frames having red (R), green (G), and blue (B) components per pixel (referred to as an RGB video including RGB frames), luma, chroma-blue, chroma-red (YUV, YCbCr, or Y′CbCr) components per pixel and/or any other suitable type of image. The sequence of frames can be captured by one or more cameras, obtained from storage, received from another device (e.g., a camera or device including a camera), or obtained from another source. In some implementations, the image frame engine 304 can convert the image frame 302 to grayscale. The image frame engine 304 can, in some cases, crop a portion of the image frame 302 that corresponds to a face. In some examples, the image frame engine 304 can perform a face detection process and/or face recognition process to detect and/recognize a face within the image frame 302. The image frame engine 304 can generate or apply a bounding box (e.g., bounding box 130 shown in FIG. 1) around the face and can crop out the image data within the bounding box to generate an input image for the 3D model fitting engine 306.

The 3D model fitting engine 306 can receive an input image (e.g., the image frame 302, the cropped bounding box around the face in the image frame 302, etc.) from the image frame engine 304. The 3D model fitting engine 306 may include an encoder and may use the input images to generate coefficients, such as shape coefficients and/or blendshape coefficients that represent the shape and/or expression of a face. Using the input image, the 3D model fitting engine 306 can perform a 3D model fitting technique to generate a 3D model (e.g., a 3DMM model) of the face (which can include the head of the person in the image frame 302). The 3D model fitting technique can include solving shape coefficients aᵢ and expression coefficients bⱼ. In some examples, the 3D model fitting can include solving for positional information related to the object. In the example of the object being a head of a person, the positional information may include pose information related to a pose of the head. For example, the pose information may indicate an angular rotation of the head with respect to the neutral position of the head. The rotation may be along a first axis (e.g., a yaw axis), a second axis (e.g., a pitch axis), and/or a third axis (e.g., a roll axis). In some cases, the 3D model fitting can also include a focal length for projection of the 3D model onto a 2D image using any suitable projection technique. In some examples, a weak perspective model can use the focal length produced by the 3D model fitting engine 306 to project the 3D vertices of the 3D model (e.g., the 3DMM) onto a 2D image. In some examples, a full perspective model can use the focal length produced by the 3D model fitting engine 306 to project the 3D vertices of the 3D model (e.g., the 3DMM) onto a 2D image. In some cases, the 3D model fitting engine 306 may be implemented using one or more ML models.

The local feature engine 308 can receive one or more input frames (e.g., local frames 303) from the image frame engine 304. In some implementations, the local feature engine 308 can be implemented using one or more machine learning (ML) models (e.g., a deep learning neural network). In some examples, the machine learning model can be trained to generate local textures for portions of the face such as the eyes and the mouth that can be combined with a full facial texture for the 3DMM generated by the 3D model fitting engine 306. In one example, the local frames 303 can include oblique frames 204A, 204B, 204C captured by user facing cameras on a head mounted XR system as illustrated in FIG. 2.

The face reconstruction engine 310 can receive the coefficients generated by the 3D model fitting engine 306 to generate the 3D model (e.g., the 3DMM). The 3D model can be generated or constructed as a linear combination of a mean face (sometimes referred to as a neutral face), facial shape basis vectors, and facial expression basis vectors. The mean face can represent an average face that can be transformed (e.g., by the shape basis vectors and expression basis vectors) to achieve the desired final 3D face shape of the 3D model. The facial shape basis vectors can be used to scale proportions of the mean face. In some cases, the facial shape basis vectors may be used to represent a fat or thin face, a small or large nose, and any adjustment to the basic facial shape. In some implementations, the facial shape basis vectors are determined based on principal component analysis (PCA). In some cases, facial expression basis vectors can represent facial expressions, such as smiling, lifting an eyebrow, blinking, winking, frowning, etc. In some cases, the face reconstruction engine 310 may be implemented using one or more ML models.

One illustrative example of facial expression basis vectors are blendshapes. As used herein, a blendshape can correspond to an approximate semantic parametrization of all or a portion of a facial expression. For example, a blendshape can correspond to a complete facial expression, or correspond to a “partial” (e.g., “delta”) facial expression.

Examples of partial expressions include raising one eyebrow, closing one eye, moving one side of the face, etc. In one example, an individual blendshape can approximate a linearized effect of the movement of an individual facial muscle. In some cases, semantic representation can be modeled to correspond with movements of one or more facial muscles.

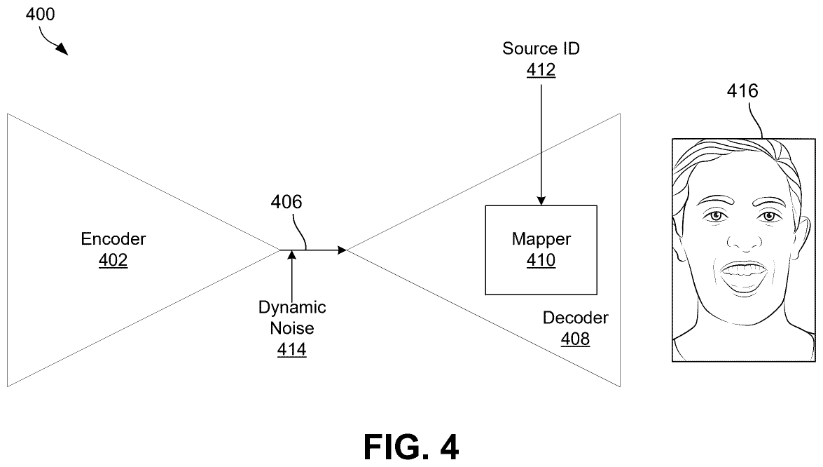

FIG. 4 is a block diagram illustrating a technique for facial blendshape avatars 400, in accordance with aspects of the present disclosure. In some cases, blendshapes may be enhanced to support representing photo-realistic avatars. Blendshapes may be generated by an encoder 402, such as one of a 3DMM fitting engine (e.g., 3D model fitting engine 306 of FIG. 3).

The encoder 402 may generate blendshape coefficients and/or shape coefficients. To support photo-realistic avatars the encoder 402 may be enhanced by training on training datasets as well as in the wild data. In some cases, training datasets may refer to images that are captured, for example using a multi-view scanner system such that subjects may be imaged from multiple angles, to generate training images with ground truth nonlinear latent code labelling. In some cases, training datasets may be generated using multiple subjects captured from multiple angles expressing a specific variety of expressions for ground truth labelling. In the wild data may refer to images captured and used for training without such ground truth nonlinear latent code labelling. In some cases, in the wild data may represent a broader range of expressions captured in less formal conditions. Mixing the training datasets and in the wild data may enhance generalizability of the encoder to help the encoder handle users beyond the specific persons represented in the training datasets.

In some cases, a particular face may be represented by an arbitrary number of blendshapes. For example, a set of blendshape coefficients may have a set number of coefficients. However, certain coefficients may cancel each other out or otherwise interfere with each other such that a particular face may be represented by multiple different set of blendshape coefficients, leading to overfitting. In some cases, the encoder 402 may be trained using a training structure to disentangle identifier information from blendshape coefficients to improve the sparsity of blendshape coefficients to help reduce overfitting.

As indicated above, the encoder 402 may pass 406 blendshape coefficients and/or shape coefficients to a decoder 408. The decoder 408 may include a mapper 410. The mapper 410 may be used to map blendshape coefficients to 3D representations of the face for the avatar. In some cases, the mapper 410 may be configured to receive a source identifier (ID) 412 during inference. The source ID 412 may be an identifier associated with a source avatar 416 to be rendered and/or captured images. The source avatar to be rendered may be different from a driver and driver ID. The driver may be the person the avatar represents and the driver ID may be an identifier for driver. In some cases, injecting the source ID 412 to the mapper 410 may allow a driver to drive a source avatar 416 that appears to be a different person from the driver, without having multiple mappers for different drivers.

Additionally, the decoder 408 may be trained to better represent outlier expressions and/or people that were not necessarily seen during training. For example, the decoder 408 may be trained with dynamic noise 414 injected into the output of the encoder 402. This injected dynamic noise 414 may further reduce overfitting and improve system stability.

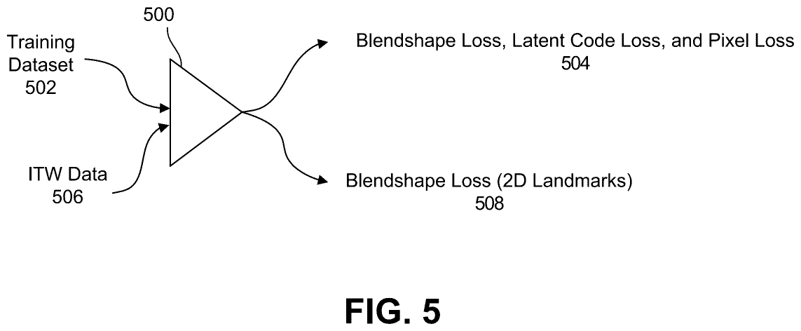

FIG. 5 illustrates a module 500 for generating facial blendshape avatars, in accordance with aspects of the present disclosure. FIG. 5 includes module 500 and module 500 may include the encoder 402 of FIG. 4, and may also include a mapper (not shown), such as mapper 410 of FIG. 4. In some cases, images from a training dataset 502 (e.g., first dataset) may be used during training of the module 500. For example, module 500 may be trained using labeled images from the training dataset 502 and losses 504, such as a blendshape loss, latent code loss, and pixel loss. In some cases, the losses 504 may be calculated based on a comparison between the output of the encoder and labels and/or pixels of the images from the training dataset 502. For example, the blendshape loss may be an L2 loss determined based on a comparison between blendshapes predicted by the module 500 being trained and a ground truth expected blendshapes. Similarly, the latent code loss may be an L2 loss determined based on a comparison between the predicted latent code from the module 500 being trained and a ground truth latent code (e.g., latent code for input to a decoder). The pixel loss may be an L2 loss determined based on a comparison between an input image and an output avatar (e.g., source avatar 416 of FIG. 4) from the decoder.

In some cases, the images in the training dataset 502 may be captured using specialized equipment for capturing training data, such as a multi-view light cage scanner. While training on such images may be good for generating accurate avatars of specific persons, generalizing may be difficult. In some cases, in addition to training on the training dataset 502, additional training may also be performed using in the wild data 506 (e.g., second dataset). In some cases, the in the world data may be data captured using, for example, without using specialized capture equipment and the in the world data may lack ground truth labels (e.g., may be unlabeled). In cases where the in the wild data 506 lacks ground truth labels (e.g., unlabeled) is used for training, the blendshape loss 508 may be used for training, and the latent code loss may not be used. In some cases, as the in the wild data 506 may not have been captured as controlled of an environment as the training dataset 502, the in the wild data 506 may include, for example, background objects, lighting changes, glare, etc., and thus a pixel loss may also not be determined for training on in the wild data 506.

In some cases, module 500 may be initially trained using the training dataset 502 and then fine-tuned on the in the wild data 506 along with the training dataset 502. For example, module 500 may be pre-trained using the training dataset 502 and after module 500 has converged using the training dataset 502, in the wild data 506 may be added.

As indicated above, a blendshape loss 508 may be determined for the in the wild data. In some cases, the in the wild data may be annotated with 2D landmarks and the blendshapes may be added on top of the 2D landmarks to provide for indirect supervision. The blendshape loss 508 may thus be determined based on a deviation between the 2D landmarks for in the annotated in the wild data, and 2D landmarks predicated by the module 500 for an expression during training. In some cases, calibrated blendshapes may be used directly and the blendshape loss 508 may be determined based on a difference the blendshapes predicted by the module 500 during training and expected blendshapes.

In some cases, the module 500 may output blendshape coefficients and shape coefficients for generating the facial avatar. The shape coefficients may describe the overall shape of the facial avatar and the blendshape coefficients may describe an expression of the facial avatar. In some cases, the blendshape coefficients may become entangled with the shape coefficients, which may make generalization more difficult due to overfitting. For example, one person may naturally have eyebrows that are higher (e.g., further from their eyes) as compared to another person. While this height difference is not due to any particular expression, it can be difficult for module 500 to determine whether a particular person is raising their eyebrows as a part of an expression or if their eyebrows are just that way, leading to potential entangling of the blendshape coefficients and shape coefficients and overfitting. To reduce overfitting, a neutral reference face shape may be used.

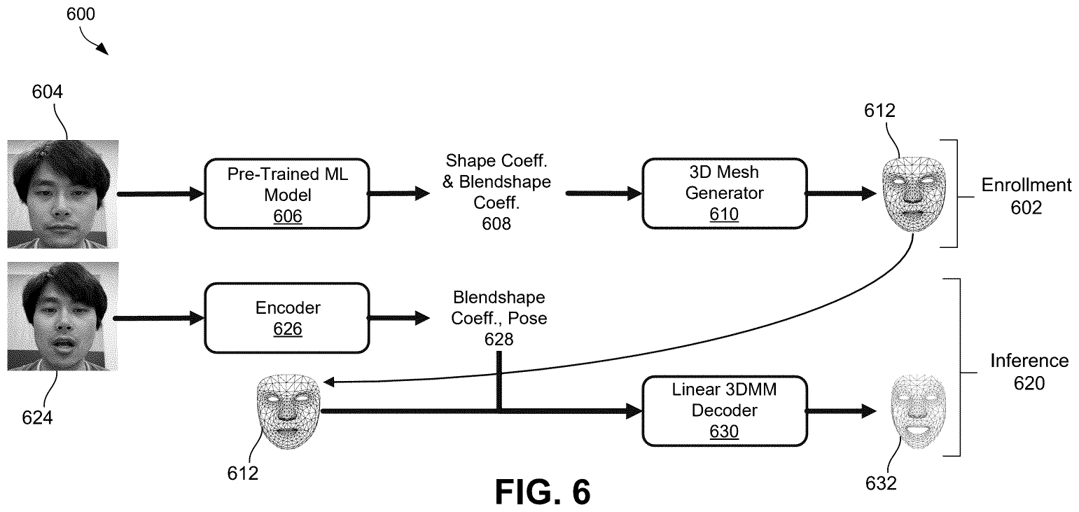

FIG. 6 is a block diagram illustrating a training structure 600 for disentangling identifier information from blendshape coefficients, in accordance with aspects of the present disclosure. In the training structure 600, an enrollment pipeline 602 may be included. During the enrollment pipeline 602 for a user (e.g., a driver), one or more image 604 of the user with a neutral face (e.g., relaxed face with no expression) may be captured. These one or more images 604 may be input to a pre-trained machine learning (ML) model 606 to generate shape coefficients and blend shape coefficients 608. In some cases, the pre-trained ML model may operate in a manner similar to an encoder. The generated shape coefficients and blend shape coefficients 608 may be input to a 3D mesh generator 610. The 3D mesh generator 610 may generate a 3D mesh model of a neutral face 612 for the user. In some cases, the 3D mesh generator 610 may operate in a manner similar to a decoder.

The 3D mesh model of the neutral face 612 may then be injected during an inference. For example, in an inference pipeline 620, one or more images 624 of the user may be captured and input to an encoder 626. In some cases, the user may have an expression on their face visible in one or more images 624. The encoder 626 may be trained to output blendshape coefficients 628 without also outputting shape coefficients. In some cases, the encoder 626 may also output an estimated pose of the user. The output blendshape coefficients 628 and the mesh model of the neutral face 612 (e.g., generated as a part of the enrollment pipeline 602) may be input to a linear 3DMM decoder 630. The decoder may use the blendshape coefficients 628 and mesh model of the neutral face 612 to generate a 3DMM mesh of the face including expression 632. In some cases, the mesh model of the neutral face 612 encodes the look and shape of the face.

Encoding the look and shape of the face in the mesh model of the neutral face 612 allows the encoder 626 to be trained to encode the expression of the user in the one or more images 624 as blendshape coefficients and helps disentangle the shape coefficients from the blendshape coefficients. For example, a user who has higher eyebrows normally as compared to another user may be encoded into the mesh model of the neutral face 612. During training of the encoder 626, the encoder 626 may be trained to focus on features indicative of different expressions when generating blendshape coefficients 628 and ignore features representative of the shape and/or look of the faces as the shape/look is fixed through the mesh model of the neutral face 612.

As indicated above, blendshapes can represent a particular face using multiple, redundant, sets of blendshape coefficients. For example, the blendshape coefficients may include a coefficient representing an eye looking to the right and another coefficient representing the eye looking to the left. If neither coefficient is set, then the eye may be rendered as looking straight. If both coefficients are set, then the two may cancel each other out and the eye may also be rendered as looking straight. As multiple combinations of coefficients may be rendered into a same 3DMM/avatar, it can be difficult for a mapper, such as mapper 410 of FIG. 4, to learn expression correspondences and avoid overfitting.

In some cases, hard constraints may be added for mutually exclusive coefficients for loss computations. In some cases, these mutually exclusive coefficients may be manually selected based on physical constraints on a face. For example, coefficients for looking right and looking left for a single eye may be mutually exclusive. Similarly, coefficients for eyes widen and eyes narrowing, cheek puffed out, and cheeks pulled in, eyes looking up and eyes looking down, etc. may also be identified as mutually exclusive.

In some cases, rather than having multiple mappers to handle different source avatar animations, it may be useful to have a decoder/mapper capable of handling multiple source avatars.

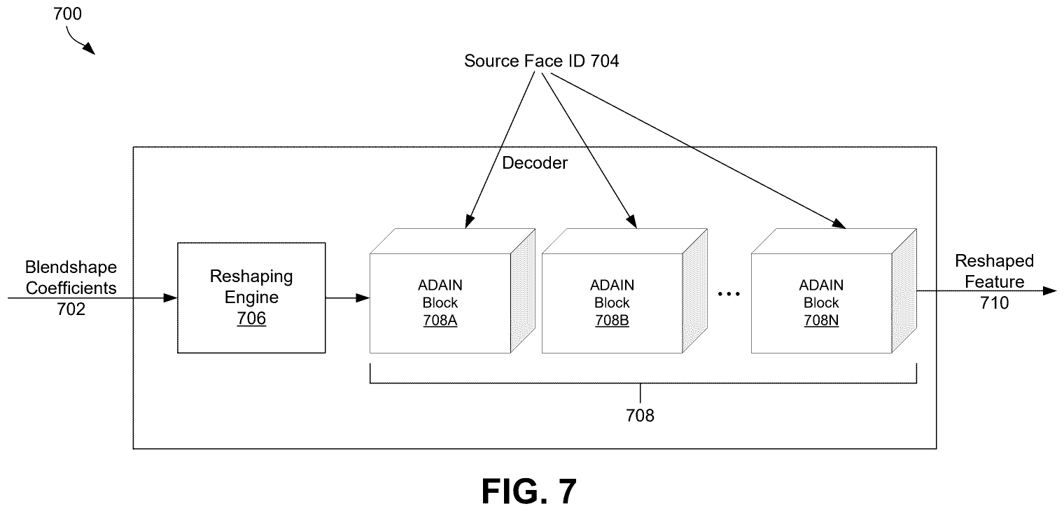

FIG. 7 is a block diagram illustrating a decoder 700 capable of supporting multiple source avatars, in accordance with aspects of the present disclosure. In some cases, the decoder 700 may receive a set of blendshape coefficients 702 along with an identifier for a source face (e.g., source face identifier 704) to use for an avatar. In some cases, the source face identifier 704 may be a face authentication vector generated based on an image of a neutral face (e.g., one or more images 604 of FIG. 6, or another neutral face image). The set of blendshape coefficients 702 may be input to a reshaping engine 706. The reshaping engine 706 may apply one or more convolution operations and reshape the input set of blendshape coefficients 702 to 2D features. The reshaping engine 706 may output the 2D features to a one or more 2D adaptive instance normalization (ADAIN) blocks 708A, 708B, . . . 708N (collectively, ADAIN blocks 708). In some cases, the ADAIN blocks 708 may perform 2D convolution operations (e.g., convolution layer plus a rectified linear unit (RELU) layer, and a pooling layer) and align a mean and variance of the 2D features with a mean and variance regressed from a face authentication vector associated with the source face identifier 704 to obtain reshaped features 710 (e.g., nonlinear code) for driving the avatar associated with the source face identifier 704 using the blendshapes. In some cases, the ADAIN blocks 708 may be used as a style GAN (e.g., generative adversarial network) that allows features (e.g., input 3D features) to be merged with a style of other features (e.g., vector associated with the source face identifier 704). In some cases, the reshaped features 710 may be specific for a particular source identifier. In some cases, the reshaped features 710 may be interpolated to represent features for another source identifier, allowing the reshaped features 710 to be generalized to another source identifier.

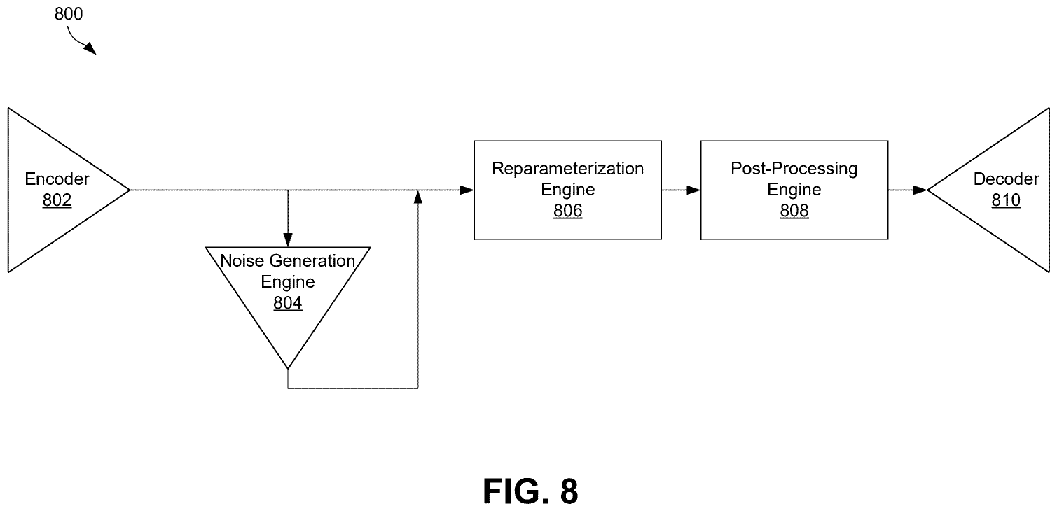

FIG. 8 is a block diagram illustrating techniques for generalizing facial blendshape generation 800, in accordance with aspects of the present disclosure. In some cases, training a decoder to generate features (e.g., nonlinear code) from a 3DMM directly may result in overfitting to expressions present in training, which may degrade the overall quality of expressions when generalizing. To better learn to represent outlier expressions that may not be present in the training, noise may be injected during training of the decoder. For example, an encoder 802 may output a set of blendshape coefficients representing a face and these blendshape coefficients may be input to a noise generation engine 804. The noise generation engine 804 may generate random gaussian noise and add the noise to the blendshape coefficients. The added noise in the blendshape coefficients may lead to more variance in expressions which may not appear in the training dataset. In some cases, the gaussian noise may be added to the blendshape by reparametrizing the gaussian noise using a differentiable transformation. For example, let z represent the gaussian noise where z˜q_{φ}(z|x) represents a conditional distribution, then the random gaussian noise variable z may be represented as a deterministic variable z=g_{φ}(∈,x), where ∈ is an auxiliary variable with independent marginal p(∈), and where g_{φ} is a vector-valued function parameterized by φ. In some cases, reparameterization may be useful as reparameterization may allow the noise to be differentiable for determining a loss value for training.

In some cases, the gaussian noise may be dynamically learned by the noise generation engine 804, for example, using a ML model, such as a neural network. In some cases, ML models may learn a standard deviation for the gaussian noise generated. In some cases, to avoid the noise standard deviation from shrinking to zero, a modified KL loss may be added such as: 0.5*mean(exp(2*log std)−1.0−2*log std), which pushes noise variance to 1. In some cases, the blendshape coefficient values may target between 0 and 1 and adding noise with a variance of 1 may be too much. In some cases, reparameterization may be used to reduce the impact of the added noise. After the noise standard deviation is learned a reparameterization step may be performed by a reparameterization engine 806. In some cases, the reparameterization engine 806 may resample noisy blendshape coefficients by 0.05*standard deviation*(a value sampled from a standard gaussian distribution with mean 0 and variance 1) to generate a real noise level based on the learned standard deviation and mean. After a real noise level is generated a standard deviation of noise may be learned and then the noise signal may be generated. The modified KL loss may push augmenting the blendshape coefficients with 0.05(std) gaussian noise and the other data terms may push the learned standard deviation to become smaller for accurate mapping. In some cases, combining the losses will let the learned standard deviation find a balance dynamically by itself. In some cases, the estimated blendshape may be used as the mean of the noise and the formula to generate the noise signal may be expressed as blendshape+0.05*standard deviation*(a value sampled from a standard gaussian distribution with mean 0 and variance 1). The reparameterization engine 806 may output reparametrized blendshape coefficients to a post-processing engine 808. The post-processing step may be used to remove multiple, mutually exclusive (e.g., duplicate) blendshapes. In some cases, noise may be added before post-processing to avoid having the added noise undermining the mutually exclusive coefficient rules. Additionally, noise generation engine 804 may be modeled as a function an input expression as the level of noise ideally should be more for some expressions than others depending on how fast the expressions are changing around that expression in latent space.

In some cases, a post-processing step for training may be added after an encoder has generated a predicted set of blendshape coefficients (e.g., reparametrized blendshape coefficients) and before the predicted set of blendshape coefficients have been passed to a decoder 810 and a loss function determined. The post-processing engine 808 may check the predicted set of blendshape coefficients for those blendshape coefficients that have been defined as mutually exclusive blendshape coefficients, such as one for an eye facing right and the eye facing left. For example, a set of mutually exclusive blendshape coefficients may be manually and/or heuristically defined and coefficients of the predicated set of blendshape coefficients may be compared to the set of mutually exclusive blendshape coefficients. If both blendshape coefficients are active (e.g., both coefficients are set, have a value, etc.), then the post-processing engine 808 may compare the blendshape coefficients and keep the blendshape coefficient with a larger value. Thus, if the eye facing right blendshape coefficient has a value of 0.1 and the eye facing left blendshape coefficient has a value of 0.25, the eye facing left blendshape coefficient is kept at 0.25 and the eye facing right blendshape coefficient is zeroed. In some cases, zeroing one of the mutually exclusive blendshape coefficients helps push the blendshape coefficients to more sparse combinations by removing processing of mutually exclusive blendshape coefficients. Losses may be determined based on the remaining blendshape coefficients (e.g., without mutually exclusive blendshape coefficients). For example, the remaining blendshape coefficients may be passed to the decoder 810 (e.g., decoder 408 of FIG. 4, linear 3DMM decoder 630 of FIG. 6) to generate a predicted features/nonlinear code for generating a 3DMM and features/nonlinear code/3DMM may be compared to a ground truth to determine the loss values.

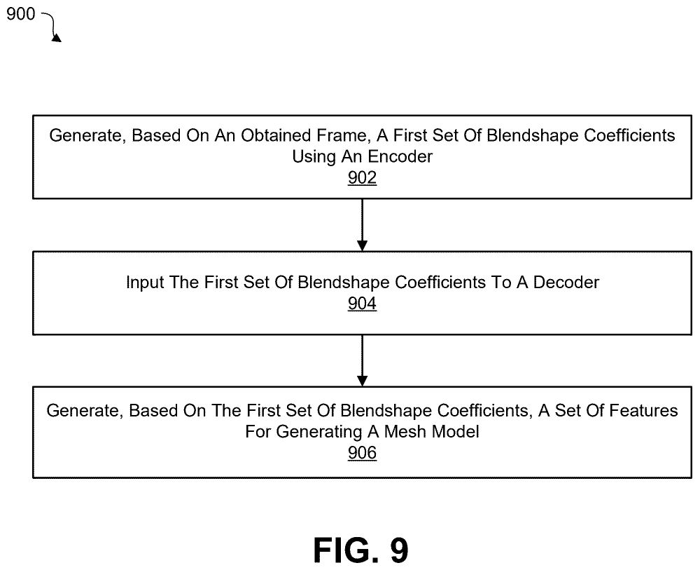

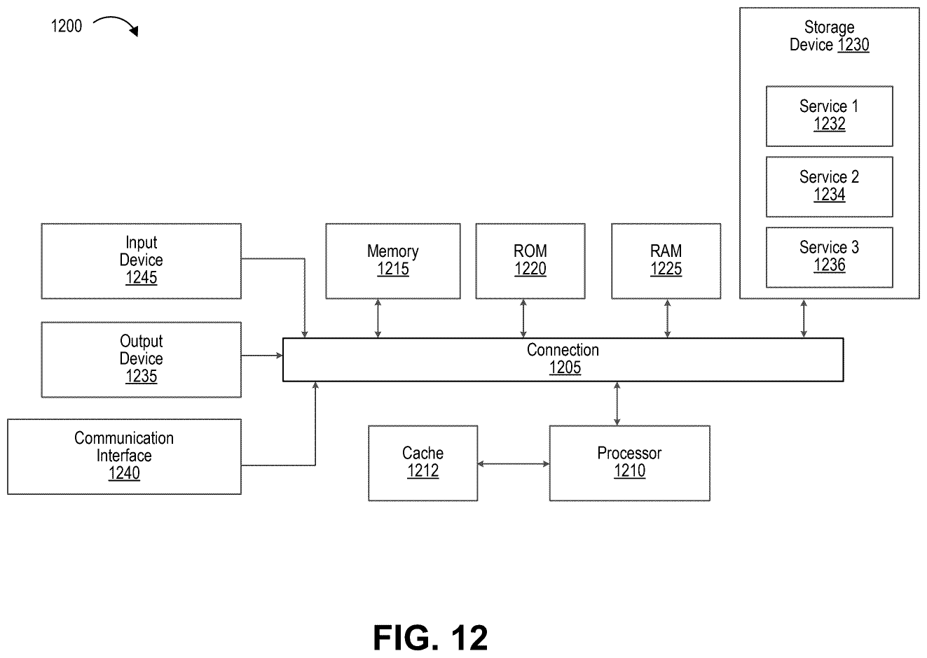

FIG. 9 illustrates a flowchart of a process 900 for generating a mesh model, in accordance with aspects of the present disclosure. The process 900 may be performed by a computing device (or apparatus) or a component (e.g., 3D modeling system 300 of FIG. 3, encoder 402 of FIG. 4, decoder 408 of FIG. 4, encoder 626 of FIG. 6, linear 3DMM decoder 630 of FIG. 6, decoder 700 of FIG. 7, encoder 802 of FIG. 8, decoder 810 of FIG. 8, processor 1210 of FIG. 12, etc.) of the computing device. Examples of the computing device can include the head mounted XR system 202 of FIG. 2, computing system 1200 of FIG. 12. The computing device may also be a mobile device (e.g., a mobile phone), an extended reality (XR) device such as a virtual reality (VR) device or augmented reality (AR) device, a vehicle or component or system of a vehicle, a network-connected wearable such as a watch, or other type of computing device. In another example, the process 900 may be performed by a computing device with the computing system 1200 shown in FIG. 12. The operations of the process 900 may be implemented as software components that are executed and run on one or more processors.

At block 902, the computing device (or component thereof) may generate, based on an obtained frame, a first set of blendshape coefficients (e.g., blendshape coefficients 628 of FIG. 6) using an encoder (e.g., encoder 402 of FIG. 4, module 500 of FIG. 5, encoder 626 of FIG. 6, encoder 802 of FIG. 8, etc.). In some cases, the encoder is trained using a first dataset (e.g., training dataset 502 of FIG. 5, etc.) and a second dataset (e.g., in the wild data 506 of FIG. 5, etc.), the first dataset including labelled training data and the second dataset including unlabeled training data. In some cases, the encoder is trained using a blendshape loss, a latent code loss, and a pixel loss determined for the first dataset and a blendshape loss determined for the second dataset.

At block 904, the computing device (or component thereof) may input the first set of blendshape coefficients to a decoder (e.g., decoder 408 of FIG. 4, linear 3DMM decoder 630 of FIG. 6, decoder 700 of FIG. 7, etc.). In some cases, the decoder is trained based on a third set of blendshape coefficients, wherein the third set of blendshape coefficients includes dynamic noise. In some examples, the dynamic noise is added to the third set of blendshape coefficients based on a standard deviation for the dynamic noise. In some cases, the decoder is trained based on a fourth set of blendshape coefficients, and wherein one or more mutually exclusive blendshape coefficients are removed from the fourth set of blendshape coefficients. In some examples, the one or more mutually exclusive blendshape coefficients are removed from the fourth set of blendshape coefficients based on a set of mutually exclusive blendshape coefficients. In some cases, coefficients of the set of mutually exclusive blendshape coefficients are manually defined.

At block 906, the computing device (or component thereof) may generate, based on the first set of blendshape coefficients, a set of features (e.g., reshaped features 710 of FIG. 7) for generating a mesh model. In some cases, the computing device (or component thereof) may receive a mesh model of a neutral face for a person captured in the obtained frame; and generate the set of features for generating the mesh model based on the first set of blendshape coefficients and the mesh model of the neutral face. In some examples, the mesh model of the neutral face is generated based on a set of shape coefficients and a second set of blendshape coefficients determined during an enrollment procedure. In some cases, the computing device (or component thereof) may receive a source face identifier associated with a source avatar; and generate set of features based on the first set of blendshape coefficients and the source face identifier. In some examples, the source face identifier comprises a vector generated based on an image of a neutral face. In some cases, the computing device (or component thereof) may generate the set of features further based on one or more adaptive instance normalization blocks. In some examples, the first set of blendshape coefficients are reshaped for use by one or more adaptive instance normalization blocks using one or more convolution operations.

In other examples, a device may include an application or function to perform some of the processes described herein (e.g., process 900 and/or any other process described herein). In some examples, the processes described herein (e.g., process 900 and/or any other process described herein) may be performed by a computing device or apparatus. In some examples, the process 900 can be performed by the 3D modeling system 300. In another example, process 900 can be performed by a computing device or system with the architecture of the computing system 1200 shown in FIG. 12.

The computing device can include any suitable device, such as a mobile device (e.g., a mobile phone), a desktop computing device, a tablet computing device, an extended reality (XR) device or system (e.g., a VR headset, an AR headset, AR glasses, or other XR device or system), a wearable device (e.g., a network-connected watch or smartwatch, or other wearable device), a server computer or system, a vehicle or computing device of a vehicle (e.g., an autonomous vehicle), a robotic device, a television, and/or any other computing device with the resource capabilities to perform the processes described herein, including the process 900. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 900 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

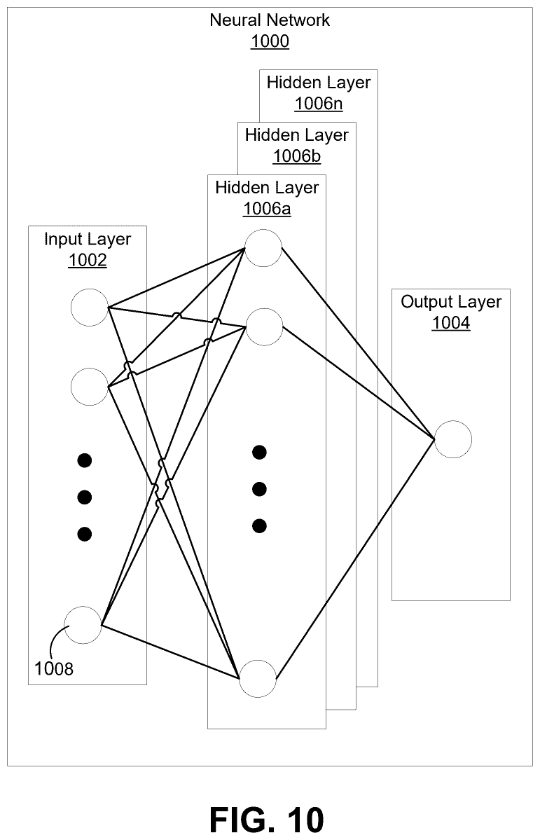

FIG. 10 is an illustrative example of a deep learning neural network 1000 that can be used by a 3D model training system. An input layer 1002 includes input data. In one illustrative example, the input layer 1002 can include data representing the pixels of an input video frame. The neural network 1000 includes multiple hidden layers 1006a, 1006b, through 1006n. The hidden layers 1006a, 1006b, through 1006n include “n” number of hidden layers, where “n” is an integer greater than or equal to one. The number of hidden layers can be made to include as many layers as needed for the given application. The neural network 1000 further includes an output layer 1004 that provides an output resulting from the processing performed by the hidden layers 1006a, 1006b, through 1006n. In one illustrative example, the output layer 1004 can provide a classification for an object in an input video frame. The classification can include a class identifying the type of object (e.g., a person, a dog, a cat, or other object).

The neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1002 can activate a set of nodes in the first hidden layer 1006a. For example, as shown, each of the input nodes of the input layer 1002 is connected to each of the nodes of the first hidden layer 1006a. The nodes of the hidden layers 1006a, 1006b, through 1006n can transform the information of each input node by applying activation functions to the information. The information derived from the transformation can then be passed to and can activate the nodes of the next hidden layer 1006b, which can perform their own designated functions. Example functions include convolutional, up-sampling, data transformation, and/or any other suitable functions. The output of the hidden layer 1006b can then activate nodes of the next hidden layer, and so on. The output of the last hidden layer 1006n can activate one or more nodes of the output layer 1004, at which an output is provided. In some cases, while nodes (e.g., node 1008) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. Once the neural network 1000 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1002 using the different hidden layers 1006a, 1006b, through 1006n in order to provide the output through the output layer 1004. In an example in which the neural network 1000 is used to identify objects in images, the neural network 1000 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 1000 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1000 is trained well enough so that the weights of the layers are accurately tuned.

For example, identifying objects in images, the forward pass can include passing a training image through the neural network 1000. The weights are initially randomized before the neural network 1000 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 1000, the output will likely include values that do not give preference to any particular class due to the weights being randomly selected at initialization. For example, if the output is a vector with the probability that the object includes different classes, the probability value for each of the different classes may be equal or at least very similar (e.g., for ten possible classes, each class may have a probability value of 0.1). With the initial weights, the neural network 1000 is unable to determine low level features and thus cannot make an accurate determination of what the classification of the object might be. A loss function can be used to analyze errors in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1000 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wi denotes weight update can be denoted as the initial weight, and η denotes a learning rate. The learning rate can be set to any suitable value, with a high learning rate including larger weight updates and a lower value indicating smaller weight updates.

The neural network 1000 can include any suitable deep network. One example includes a convolutional neural network (CNN), which includes an input layer and an output layer, with multiple hidden layers between the input and out layers. An example of a CNN is described below with respect to FIG. 8. The hidden layers of a CNN include a series of convolutional, nonlinear, pooling (for downsampling), and fully connected layers. The neural network 1000 can include any other deep network other than a CNN, such as an autoencoder, a deep belief nets (DBNs), a Recurrent Neural Networks (RNNs), among others.

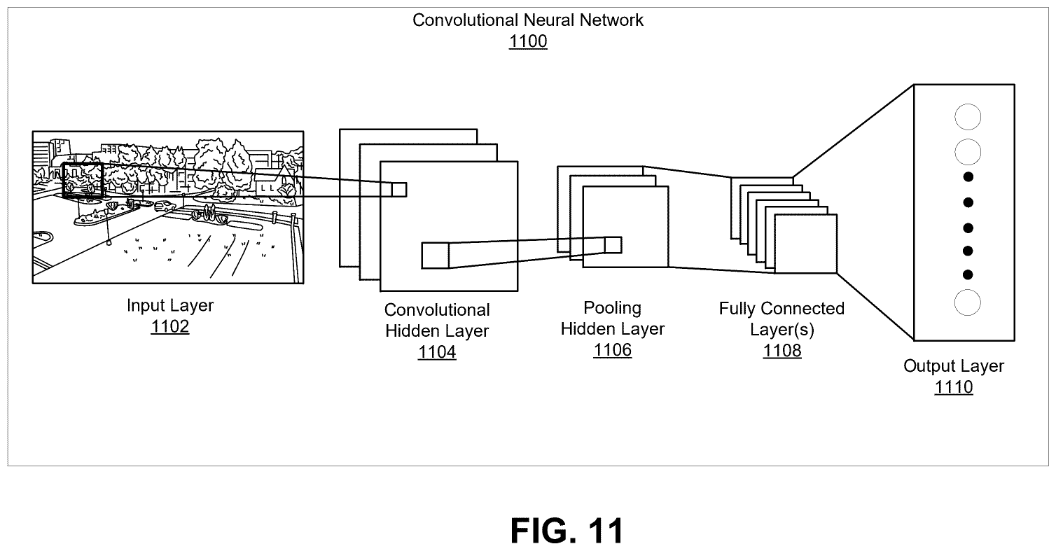

FIG. 11 is an illustrative example of a convolutional neural network (CNN 1100). The input layer 1102 of the CNN 1100 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1104, an optional non-linear activation layer, a pooling hidden layer 1106, and fully connected hidden layers 1108 to get an output at the output layer 1110. While only one of each hidden layer is shown in FIG. 11, one of the ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 is the convolutional hidden layer 1104. The convolutional hidden layer 1104 analyzes the image data of the input layer 1102. Each node of the convolutional hidden layer 1104 is connected to a region of nodes (pixels) of the input image called a receptive field. The convolutional hidden layer 1104 can be considered as one or more filters (each filter corresponding to a different activation or feature map), with each convolutional iteration of a filter being a node or neuron of the convolutional hidden layer 1104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1104. Each connection between a node and a receptive field for that node learns a weight and, in some cases, an overall bias such that each node learns to analyze its particular local receptive field in the input image. Each node of the convolutional hidden layer 1104 will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1104 is due to each node of the convolutional layer being applied to its corresponding receptive field. For example, a filter of the convolutional hidden layer 1104 can begin in the top-left corner of the input image array and can convolve around the input image. As noted above, each convolutional iteration of the filter can be considered a node or neuron of the convolutional hidden layer 1104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1104.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1104.

The mapping from the input layer to the convolutional hidden layer 1104 is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1104 can include several activation maps in order to identify multiple features in an image. The example shown in FIG. 11 includes three activation maps. Using three activation maps, the convolutional hidden layer 1104 can detect three different kinds of features, with each feature being detectable across the entire image.

In some examples, a non-linear hidden layer can be applied after the convolutional hidden layer 1104. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1100 without affecting the receptive fields of the convolutional hidden layer 1104.

The pooling hidden layer 1106 can be applied after the convolutional hidden layer 1104 (and after the non-linear hidden layer when used). The pooling hidden layer 1106 is used to simplify the information in the output from the convolutional hidden layer 1104. For example, the pooling hidden layer 1106 can take each activation map output from the convolutional hidden layer 1104 and generates a condensed activation map (or feature map) using a pooling function. Max-pooling is one example of a function performed by a pooling hidden layer. Other forms of pooling functions are used by the pooling hidden layer 1106, such as average pooling, L2-norm pooling, or other suitable pooling functions. A pooling function (e.g., a max-pooling filter, an L2-norm filter, or other suitable pooling filter) is applied to each activation map included in the convolutional hidden layer 1104. In the example shown in FIG. 11, three pooling filters are used for the three activation maps in the convolutional hidden layer 1104.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1104 having a dimension of 24×24 nodes, the output from the pooling hidden layer 1106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting the results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1106 to every one of the output nodes in the output layer 1110. Using the example above, the input layer includes 28×28 nodes encoding the pixel intensities of the input image, the convolutional hidden layer 1104 includes 3×24×24 hidden feature nodes based on application of a 5×5 local receptive field (for the filters) to three activation maps, and the pooling hidden layer 1106 includes a layer of 3×12×12 hidden feature nodes based on application of max-pooling filter to 2×2 regions across each of the three feature maps. Extending this example, the output layer 1110 can include ten output nodes. In such an example, every node of the 3×12×12 pooling hidden layer 1106 is connected to every node of the output layer 1110.

The fully connected hidden layers 1108 can obtain the output of the previous pooling hidden layer 1106 (which should represent the activation maps of high-level features) and determines the features that most correlate to a particular class. For example, the fully connected hidden layers 1108 can determine the high-level features that most strongly correlate to a particular class, and can include weights (nodes) for the high-level features. A product can be computed between the weights of the fully connected hidden layers 1108 and the pooling hidden layer 1106 to obtain probabilities for the different classes. For example, if the CNN 1100 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1110 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability of a class can be considered a confidence level that the object is part of that class.

FIG. 12 is a diagram illustrating an example of a system for implementing certain aspects of present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the functions for which the component is described. In some aspects, the components can be physical or virtual devices.

Example computing system 1200 includes at least one processing unit (CPU or processor 1210) and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine the location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but there could be additional steps not included in the figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, mobile phones (e.g., smartphones or other types of mobile phones), tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure.

A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating a mesh model, comprising: at least one memory; and at least one processor coupled to the at least one memory, wherein the at least one processor is configured to: generate, based on an obtained frame, a first set of blendshape coefficients using an encoder, wherein the encoder is trained using a first dataset and a second dataset, the first dataset including labelled training data and the second dataset including unlabeled training data; input the first set of blendshape coefficients to a decoder; and generate, based on the first set of blendshape coefficients, a set of features for generating a mesh model.

Aspect 2. The apparatus of Aspect 1, wherein the encoder is trained using a blendshape loss, a latent code loss, and a pixel loss determined for the first dataset and a blendshape loss determined for the second dataset.

Aspect 3. The apparatus of Aspects 1-2, wherein at least one processor is further configured to: receive a mesh model of a neutral face for a person captured in the obtained frame; and generate the set of features for generating the mesh model based on the first set of blendshape coefficients and the mesh model of the neutral face.

Aspect 4. The apparatus of Aspect 3, wherein the mesh model of the neutral face is generated based on a set of shape coefficients and a second set of blendshape coefficients determined during an enrollment procedure.

Aspect 5. The apparatus of any of Aspects 1-4, wherein the at least one processor is further configured to: receive a source face identifier associated with a source avatar; and generate the set of features based on the first set of blendshape coefficients and the source face identifier.

Aspect 6. The apparatus of Aspect 5, wherein the source face identifier comprises a vector generated based on an image of a neutral face, and wherein at least one processor is configured to generate the set of features further based on one or more adaptive instance normalization blocks.

Aspect 7. The apparatus of Aspect 6, wherein the first set of blendshape coefficients are reshaped for use by one or more adaptive instance normalization blocks using one or more convolution operations.

Aspect 8. The apparatus of any of Aspects 1-7, wherein the decoder is trained based on a third set of blendshape coefficients, wherein the third set of blendshape coefficients includes dynamic noise.

Aspect 9. The apparatus of Aspect 8, wherein the dynamic noise is added to the third set of blendshape coefficients based on a standard deviation for the dynamic noise.

Aspect 10. The apparatus of any of Aspects 1-9, wherein the decoder is trained based on a fourth set of blendshape coefficients, and wherein one or more mutually exclusive blendshape coefficients are removed from the fourth set of blendshape coefficients.

Aspect 11. The apparatus of Aspect 10, wherein the one or more mutually exclusive blendshape coefficients are removed from the fourth set of blendshape coefficients based on a set of mutually exclusive blendshape coefficients.

Aspect 12. The apparatus of Aspect 11, wherein coefficients of the set of mutually exclusive blendshape coefficients are manually defined.

Aspect 13. A method for generating a mesh model, comprising: generating, based on an obtained frame, a first set of blendshape coefficients using an encoder, wherein the encoder is trained using a first dataset and a second dataset, the first dataset including labelled training data and the second dataset including unlabeled training data; inputting the first set of blendshape coefficients to a decoder; and generating, based on the first set of blendshape coefficients, a set of features for generating a mesh model.

Aspect 14. The method of Aspect 13, wherein the encoder is trained using a blendshape loss, a latent code loss, and a pixel loss determined for the first dataset and a blendshape loss determined for the second dataset.

Aspect 15. The method of any of Aspects 13-14, further comprising: receiving a mesh model of a neutral face for a person captured in the obtained frame; and generating the set of features for generating the mesh model based on the first set of blendshape coefficients and the mesh model of the neutral face.

Aspect 16. The method of Aspect 15, wherein the mesh model of the neutral face is generated based on a set of shape coefficients and a second set of blendshape coefficients determined during an enrollment procedure.

Aspect 17. The method of any of Aspects 13-16, further comprising: receiving a source face identifier associated with a source avatar; and generating the set of features based on the first set of blendshape coefficients and the source face identifier.

Aspect 18. The method of Aspect 17, wherein the source face identifier comprises a vector generated based on an image of a neutral face, and further comprising generating the set of features further based on one or more adaptive instance normalization blocks.

Aspect 19. The method of Aspect 18, wherein the first set of blendshape coefficients are reshaped for use by the one or more adaptive instance normalization blocks using one or more convolution operations.

Aspect 20. The method of any of Aspects 13-19, wherein the decoder is trained based on a third set of blendshape coefficients, wherein the third set of blendshape coefficients includes dynamic noise.

Aspect 21. The method of Aspect 20, wherein the dynamic noise is added to the third set of blendshape coefficients based on a standard deviation for the dynamic noise.

Aspect 22. The method of any of Aspects 13-21, wherein the decoder is trained based on a fourth set of blendshape coefficients, and wherein one or more mutually exclusive blendshape coefficients are removed from the fourth set of blendshape coefficients.

Aspect 23. The method of Aspect 22, wherein the one or more mutually exclusive blendshape coefficients are removed from the fourth set of blendshape coefficients based on a set of mutually exclusive blendshape coefficients.

Aspect 24. The method of Aspect 23, wherein coefficients of the set of mutually exclusive blendshape coefficients are manually defined.

Aspect 25. A non-transitory computer-readable medium having stored thereon instructions that, when executed by at least one processor, cause the at least one processor to perform any of the operations of Aspects 13-24

Aspect 31: An apparatus comprising one or more means for performing any of the operations of Aspects 13 to 24.

What is claimed is:

1. An apparatus for generating a mesh model, comprising:
at least one memory; and
at least one processor coupled to at least one memory, wherein at least one processor is configured to:
generate, based on an obtained frame, a first set of blendshape coefficients using an encoder, wherein the encoder is trained using a first dataset and a second dataset, the first dataset including labelled training data and the second dataset including unlabeled training data;
input the first set of blendshape coefficients to a decoder; and
generate, based on the first set of blendshape coefficients, a set of features for generating a mesh model.

2. The apparatus of claim 1, wherein the encoder is trained using a blendshape loss, a latent code loss, and a pixel loss determined for the first dataset and a blendshape loss determined for the second dataset.

3. The apparatus of claim 1, wherein at least one processor is further configured to:
receive a mesh model of a neutral face for a person captured in the obtained frame; and
generate the set of features for generating the mesh model based on the first set of blendshape coefficients and the mesh model of the neutral face.

4. The apparatus of claim 3, wherein the mesh model of the neutral face is generated based on a set of shape coefficients and a second set of blendshape coefficients determined during an enrollment procedure.

5. The apparatus of claim 1, wherein at least one processor is further configured to:
receive a source face identifier associated with a source avatar; and
generate the set of features based on the first set of blendshape coefficients and the source face identifier.

6. The apparatus of claim 5, wherein the source face identifier comprises a vector generated based on an image of a neutral face, and wherein at least one processor is configured to generate the set of features further based on one or more adaptive instance normalization blocks.

7. The apparatus of claim 6, wherein the first set of blendshape coefficients are reshaped for use by the one or more adaptive instance normalization blocks using one or more convolution operations.

8. The apparatus of claim 1, wherein the decoder is trained based on a third set of blendshape coefficients, wherein the third set of blendshape coefficients includes dynamic noise.

9. The apparatus of claim 8, wherein the dynamic noise is added to the third set of blendshape coefficients based on a standard deviation for the dynamic noise.

10. The apparatus of claim 1, wherein the decoder is trained based on a fourth set of blendshape coefficients, and wherein one or more mutually exclusive blendshape coefficients are removed from the fourth set of blendshape coefficients.

11. The apparatus of claim 10, wherein the one or more mutually exclusive blendshape coefficients are removed from the fourth set of blendshape coefficients based on a set of mutually exclusive blendshape coefficients.

12. The apparatus of claim 11, wherein coefficients of the set of mutually exclusive blendshape coefficients are manually defined.

13. A method for generating a mesh model, comprising:
generating, based on an obtained frame, a first set of blendshape coefficients using an encoder, wherein the encoder is trained using a first dataset and a second dataset, the first dataset including labelled training data and the second dataset including unlabeled training data;
inputting the first set of blendshape coefficients to a decoder; and
generating, based on the first set of blendshape coefficients, a set of features for generating a mesh model.

14. The method of claim 13, wherein the encoder is trained using a blendshape loss, a latent code loss, and a pixel loss determined for the first dataset and a blendshape loss determined for the second dataset.

15. The method of claim 13, further comprising:
receiving a mesh model of a neutral face for a person captured in the obtained frame; and
generating the set of features for generating the mesh model based on the first set of blendshape coefficients and the mesh model of the neutral face.

16. The method of claim 15, wherein the mesh model of the neutral face is generated based on a set of shape coefficients and a second set of blendshape coefficients determined during an enrollment procedure.

17. The method of claim 13, further comprising:
receiving a source face identifier associated with a source avatar; and
generating the set of features based on the first set of blendshape coefficients and the source face identifier.

18. The method of claim 17, wherein the source face identifier comprises a vector generated based on an image of a neutral face, and further comprising generating the set of features further based on one or more adaptive instance normalization blocks.

19. The method of claim 18, wherein the first set of blendshape coefficients are reshaped for use by the one or more adaptive instance normalization blocks using one or more convolution operations.

20. The method of claim 13, wherein the decoder is trained based on a third set of blendshape coefficients, wherein the third set of blendshape coefficients includes dynamic noise.
